(19) United States
(12) Patent Application Publication
(10) Pub. No.: US 2008/0165548 A1
(43) Pub. Date: Jul. 10, 2008

(54) Vehicle lighting assembly

(75) Inventors: Akihiro Misawa, Aichi-ken (JP); Chiharu Totani, Aichi-ken (JP); Tatsuya Oba, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/004,509

(22) Filed: Dec. 21, 2007

(30) Foreign Application Priority Data
Dec. 27, 2006 (JP) 2006-351635
Dec. 27, 2006 (JP) 2006-351636
Jan. 10, 2007 (JP) 2007-001873

(51) Int. Cl. B60Q 1/00

(52) U.S. Cl. 362/487

(57) ABSTRACT

There is provided a vehicle lighting assembly, which includes a plurality of light sources, and a light guiding body having a light incident portion and a reflecting portion corresponding to the light sources on a back surface side, for emitting a light generated when a light being incident from the light incident portion is reflected by the reflecting portion from a front portion, wherein the light guiding body is divided into a plurality of blocks whose emergent light modes are different, and a reflection and diffusion area is formed on a boundary portion between two adjacent blocks.

### BACKGROUND OF THE INVENTION

1. Field of the Invention

The present invention relates to a vehicle lighting assembly and, more particularly, an improvement of a vehicle lighting assembly such as a rear combination lamp, or the like.

2. Related Art

In the lamp equipment such as the rear combination lamp, the high mounted stop lamp, or the like, a desired light is emitted by irradiating a light of the light source to the outside via the outer lens (design cover). For example, in the rear combination lamp using the LED lamp as the light source, as shown in FIG. 15, an LED lamp 152 is arranged on the inner side of an outer lens 151, and a reflector 153 is provided around the LED lamp 152 (see JP-A-2005-123092, for example). In such configuration, a light of the LED lamp 102 travels forward directly or via the reflector 153, and is radiated to the outside through the outer lens 151.

In the above-mentioned rear combination lamp using the LED lamp as the light source, or the like, apart from the case where it is preferable from a design aspect that the LED lamp is positively shown, it is not preferable that the LED lamp is seen from the outside. Therefore, reduction of the brightness unevenness is achieved by applying a light diffusing process (e.g. formation of fine recesses) to the surface of the outer lens or devising a shape of the reflector, so that the LED lamp can be made inconspicuous. However, since the LED lamp is arranged on the inside of the outer lens, such LED lamp is inevitably positioned insight of the observer. As a result, even though such measures are adopted, it is difficult to conceal perfectly the presence of the LED lamp.

Further, in the lamp equipment such as the rear combination lamp, or the like for giving two kinds or more of luminous displays, a light is emitted in a predetermined luminous mode from two adjacent blocks or more respectively. In this case, in order to improve a visibility of the luminous display and the design property in giving the luminous display, it is desired that a light should be emitted only from the blocks associated with the luminous display and a light leakage to adjacent blocks should not be caused. In order to meet the requests, various measures are taken such that the rib is provided on the back surface of the outer lens to project, the light shielding wall is provided on the back surface side of the outer lens as a separate body, or the like (see JP-A7-288008, for example).

The above measure is effective in preventing the light leakage caused before the light gets to the outer lens. However, since the light leakage is caused due to light propagation/diffusion in the inside of the lens, in some cases it is impossible to say that the above measure is good enough. In particular, in the case of such a structure that the luminous display is given by utilizing positively the light propagating action of the lens, the light leakage caused due to light propagation/diffusion in the inside of the lens becomes inevitably conspicuous. Also, in such structure, the light source is arranged in vicinity to the lens to introduce the light effectively into the lens. Therefore, it is difficult to make sure of the space in which the light shielding wall or the rib utilized for the measure is provided.

On the other hand, conventionally, following measures are taken against the heat generation of the lamp unit in the vehicle lighting assembly. For example, in JP-A-2005-122945, the structure for cooling the LED lamp by guiding directly an outer air sucked through a clearance between the housing and the LED lamp to the LED lamp is disclosed. Also, in JP-A-2003-5121, the structure for cooling the inside of the housing by causing a natural ventilation based on a natural convection being generated due to a temperature difference of an air between inside and outside of the housing is disclosed.

The rear combination lamp in which the tail/stop lamp and the turn lamp are constructed integrally is used. Normally the tail/stop lamp has a high frequency in use, but conversely the turn lamp has a low frequency in use. Since an amount of generated heat is different due to difference in the frequency in use, a deviation in distribution of the generated heat is caused in the housing of the rear combination lamp. An improvement in a cooling efficiency can be expected if the cooling structure is employed with regard to such deviation, nevertheless such cooling structure has not been particularly discussed up to now.

### SUMMARY OF THE INVENTION

In view of the above circumstances, it is an object of the present invention to achieve an improvement of the design property by preventing such a situation that an observer catches sight of a light source as well as the light leakage to the adjacent blocks in the vehicle lighting assembly.

Further, it is another object of the present invention to provide a structure for cooling the inside of a rear combination lamp effectively.

In order to solve the problem, one aspect of the present invention is constructed as follows. That is, a vehicle lighting assembly includes a plurality of light sources; and a light guiding body having a light incident portion and a reflecting portion corresponding to the light sources on a back surface side, for emitting a light generated when a light being incident from the light incident portion is reflected by the reflecting portion from a front portion; wherein the light guiding body is divided into a plurality of blocks whose emergent light modes are different, and a reflection and diffusion area is formed on a boundary portion between two adjacent blocks.

In the above configuration, the reflection and diffusion area formed on the boundary portion between two adjacent blocks acts as a barrier to the light that propagates/diffuses in the light guiding portion. Therefore, it can be prevented that the light leaks/diffuses beyond the boundary between the blocks. As a result, a boundary (parting) of each block occurring in emitting the light becomes clear and thus the luminous display that is excellent in a design property and a visibility can be provided. In contrast, unlike the configuration in the related art, the reflecting portion (reflector) utilized in controlling the direction of light, etc. is constructed integrally with the light guiding body as the lens. Therefore, simplification of the structure, a reduction of the number of components, and a reduction in size can be achieved. Also, a good light guiding action can be produced by an action of the reflecting portion provided on the back surface side of the light guiding portion, and the light emission with small brightness unevenness can be easily obtained. In addition, the front side of the light guiding body on the back surface side of which the reflecting portion is formed serves as the design surface (light emitting surface). Therefore, peculiar stereoscopic effect/crystal feeling is produced and the vehicle lighting assembly with the high design property can be provided in the non-lighting mode as well as the lighting mode.

Another aspect of the present invention is constructed as follows. That is, a vehicle lighting assembly includes a light guiding body having a front light emitting surface, a back surface that underwent a light reflecting process, and a side edge surface; and a light source arranged in a position that oppose to the side end surface; wherein the light guiding body has a reflex reflector formed of an elongated portion that is elongated to conceal the light source, and an external light, which goes directly to the side edge surface, out of the external light that is incident on the light guiding body via the front light emitting surface is totally reflected by a boundary of a side edge portion.

According to the above configuration, the elongated portion functions as the shielding member for the light source, and thus it can be prevented that the light source is viewed directly from the outside via the light guiding body. Also, such an additional function can be provided that, because the elongated portion is used as the reflex reflector, a person outside can be informed of the presence of the lighting assembly (actually the presence of the vehicle to which the lighting assembly is applied) by the retroreflection light. In addition, because the reflex reflector is provided as a part of the light guiding body, compactification of the lighting assembly can be achieved and the design property can be improved.

In contrast, in the above configuration, the external light that goes directly to the side edge surface out of the external light that is incident on the light guiding body via the front light emitting surface is totally reflected. Since the total reflection of the external light is caused in this manner, it becomes hard to see the light source through the front light emitting surface of the light guiding body. That is, it can be prevented effectively that the light source is seen through the front light emitting surface of the light guiding body. In this manner, according to the present invention, although a configuration is simple, it can be prevented effectively that the light source is seen from the outside and the lighting assembly with excellent design property can be provided.

Another aspect of the present invention provides a rear combination lamp given in the following. That is, a rear combination lamp includes a tail/stop lamp portion for emitting a light of a first lamp; a turn lamp portion provided over the tail/stop lamp portion, for emitting a light of a second lamp; and a housing for housing the first lamp and the second lamp therein; wherein the tail/stop lamp portion and the turn lamp portion are in communication with each other in the housing, and the housing has a first vent hole near the first lamp and a second vent hole near the second lamp.

In the rear combination lamp of the present invention, the first vent hole acts as a suction hole and the second vent hole acts as an exhaust port. Since the tail/stop lamp portion whose frequency in use is high is arranged on the lower side, an updraft is generated in the housing, so that the suction via the first vent hole and the exhaustion via the second vent hole can be promoted. Also, since the first vent hole is provided near the first lamp, the first lamp is cooled by an external air that flows in through the first vent hole. In addition, since the second vent hole is provided near the second lamp, a heat generated from the second lamp is discharged to the outside together with the air that flows out from the second vent hole. As a result, a cooling of the overall equipment is carried out effectively. According to such configuration of the present invention, since the frequency in use of the lamp is taken into consideration, the effective cooling can be realized although the simple structure is employed.

### BRIEF DESCRIPTION OF THE DRAWINGS

FIG. 1 is a view explaining an angle of a surface constituting a reflecting portion.

FIG. 2 is a view explaining configurations of a reflection and diffusion area and a scattered reflection area in the present invention.

FIG. 3 is a perspective view of a car body rear portion to which a rear combination lamp 1 as a first embodiment of the present invention.

FIG. 4 is a front view of the rear combination lamp 1.

FIG. 5 is a sectional view taken along an V-V line position in FIG. 4.

FIG. 6 A plan view showing schematically a light emitting state of a tail/stop lamp portion 10.

FIG. 7 A view explaining an angle between a lens front 31 and a first light incident surface 32a.

FIG. 8 is a sectional view of a lens 30a equipped with the first light incident surface 32a as an inclined surface in another example of the present invention.

FIG. 9 is a front view of the rear combination lamp 201 according to a second embodiment.

FIG. 10 is a sectional view taken along an X-X line in FIG. 9.

FIG. 11 is a plan view showing schematically a light emitting state of a tail/stop lamp portion 210.

FIG. 12 is a sectional view of a lens 230 equipped with the first light incident surface 232a as an inclined surface in a third embodiment of the present invention.

FIG. 13 is a front view of a rear combination lamp 300 as still another embodiment of the present invention.

FIG. 14 is a sectional view taken along a XIV-XIV line in FIG. 13.

FIG. 15 is a sectional view of a configurative example of the rear combination lamp in the related art.

### DETAILED DESCRIPTION OF THE PREFERRED EMBODIMENT

In a vehicle lighting assembly of the present invention, a light incident on a light guiding body (lens) from a light source is reflected by a reflecting portion on the back surface side of the light guiding body, and is converted into a light directed in the front direction of the light guiding body. In a case that a light of a light source is incident on a side edge surface of the light guiding body, the side edge surface of the light guiding body is used as a light incident surface (or light incident portion). In contrast, a light reflecting process is applied to the back surface side of the light guiding body and thus a light reflecting surface (or light reflecting portion) is formed. Then, the light that travels in the direction toward the front light emitting surface is generated by a light reflecting action of this light reflecting surface. In this manner, in the present invention, the front surface of the light guiding body acts as a luminescent surface, i.e., an outer surface of the lighting assembly. That is, when the observer views the lighting assembly of the present invention from the outside, the luminescent surface of the light guiding body can be observed directly (without the intervention of a cover, or the like).

In order to lessen a brightness unevenness of the light emitted from the front of the light guiding body, it is preferable that a shape of the light guiding body should be designed in such a way that a distance between the front surface and the back surface of the light guiding body becomes shorter continuously or stepwise as the concerned portion goes away from the side edge surface serving as the light incident portion. According to such design, a light outputting efficiency can be enhanced even in the area distant from the light source, and as a result the light can be emitted with a minor difference of brightness.

The light reflecting process applied to the back surface of the light guiding body is carried out by the deposition of metal material (aluminum, silver, chromium, or the like), the metal plating, the sputter, the pasting of a metal film, or the like, for example. Otherwise, a surface roughening may be applied to the back surface of the light guiding body or recesses may be formed in a predetermined pattern.

The number of employed light sources and a size of the light guiding body can be decided by taking account of a luminance brightness, etc. necessary for the lighting assembly. A required number of light sources are prepared every block of the light guiding body. An arranging mode of the light sources is not particularly restricted. In this case, it is preferable that the light sources should be arranged in vicinity of the light guiding body to enhance an incident rate to the light guiding body (introduction efficiency). In particular, it is preferable that the light sources should be arranged such that the luminescent surfaces of the light sources and the surface of the light guiding body are connected mutually to have no substantial clearance between them. These light sources are aligned along the side edge surface of the light guiding body, for example.

The type of the light source is not particularly restricted, and an LED lamp, a bulb, etc. can be employed. Out of them, it is preferable that the LED lamp should be employed. This is because the LED lamp is small in size and thus a size reduction of the lighting assembly can be attained. Also, the LED lamp has such advantages that an amount of generated heat is small and the thermal influence on surrounding members can be reduced. In addition, the LED lamp has such advantages that a driving power is small and a lifetime is long. The type of the LED lamp is not particularly restricted, and various types of LED lamps such as shell type, chip type, and the like can be employed. In particular, the LED lamp whose light distribution is controlled by the lens, or the like is preferable.

A color of the light source can be selected arbitrarily. Also, when a plurality of light sources are employed, a luminous color can be changed by controlling them.

The light guiding body may be divided into two sections, or more. The light is emitted from front areas of respective blocks in peculiar luminous modes respectively. In the case where the present invention is applied to the rear combination lamp of the car, for example, two sections consisting of the block for giving the tail lamp display and the stop lamp portion (tail/stop lamp portion) and the block for giving the turn signal display (turn lamp portion) are provided, or three sections consisting of these two blocks and the block for giving the back lamp display (back lamp portion) are provided.

Further, when the lighting assembly of the present invention is observed from the outside, the light reflecting surface formed on the back surface side can be seen through the front light emitting surface. Therefore, this light reflecting surface becomes an important element constituting a design of the lighting assembly of the present invention. As a result, an improvement of the design property of the lighting assembly can be attained by giving a high design property to the light reflecting surface. For example, recess portions are formed continuously in a predetermined pattern on the back surface of the light guiding portion. The light reflecting surface on which the recess portions are continued continuously is formed by applying the above light reflecting process to the back surface. In this manner, since the shape of the light reflecting surface depends on the shape of the back surface of the light guiding portion, the light reflecting surface can be formed easily in a desired shape.

A light incident portion is formed on the back surface side of the light guiding body. The light incident portion is an area to which the light source opposes. A mode of the light incident portion is not particularly restricted, but a position, a shape, an angle, etc. of the light incident portion are set such that the introduced light reaches effectively the reflecting portion described later. It is preferable from an aspect of the light introducing efficiency that the surface on which the light of the light source is incident (light incident plane) should be formed smoothly. A plurality of light incident portions may be provided. For example, the light incident portions of the same number as the used light sources may be provided. In this case, such a configuration can be provided that lights of a plurality of light sources are introduced via one light incident portion.

The light incident portion formed as a concave shape to involve the light source may be provided. Such light incident portion is effective in enhancing an introducing efficiency of a light from the light source. Also, when the light incident portion in this mode is employed, the light source (or a part of the light source) can be housed in the light guiding body by employing the light incident portion being shaped into this mode, and a miniaturization of the lighting assembly can be achieved. In this case, when the light source that emits the light in the lateral direction (as a concrete example, a laterally emitting LED lamp) is employed, normally the light incident portion in this mode is employed.

It is preferable that the light guiding body should be formed such that the neighborhood of the light incident portion is thicker than the edge portion of the light guiding body. For example, a thickness of the neighborhood of the light incident portion (a distance between the front surface and the back surface) is set 2.5 times to 25 times thicker than the edge portion of the light guiding body (the edge portion is a portion whose distance from the outer edge of the light guiding body is within 5% of a height of the light guiding body). More concretely, the neighborhood of the light incident portion is formed thickest, and this thickness is set to 15 mm to 50 mm, preferably 25 mm to 40 mm, for example. It is feared that a light introducing efficiency is lowered and the influence on a light guiding action is caused if this thickness is excessively thin, while the light guiding portion becomes thicker than it needs and an increase of a weight and an increase of a production cost are caused if this thickness is excessively thick. In contrast, an average thickness of the edge portion of the light guiding body is set to 3 mm to 20 mm, preferably 5 mm to 10 mm, for example. In this manner, use of such thick light guiding body is effective in preventing the situation that the light source and the connection portion of the housing are observed from the outside through the light guiding body. Also, because a good light guiding action can be produced, such structure is effective in causing all over the light guiding body including the edge portion to emit the light.

A plurality of reflecting portions and coupling portions are formed on the back surface of the light guiding body to be connected alternately in the direction that goes away from the side edge surface of the light guiding body. Herein, the reflecting portion reflects the light being introduced and reached there by its boundary and generates a light in the direction toward the front light emitting surface. In this configuration, a light of a light source is introduced into the light guiding body and then is reflected by a plurality of reflecting portions connected via the coupling portions. This resultant light is emitted from the front of the light guiding body. As the result that a light guiding action of the light guiding body and a reflecting action of a plurality of reflection portions are utilized, the light diffuses throughout the light guiding body including the edge portion and thus the light can be emitted from all over the front surface of the light guiding body including the edge portion.

For example, a plurality of reflecting portions that are connected with the intervention of the coupling portions are formed in the direction to go away from the light incident portion. In this case, the reflecting portion and the coupling portion are formed alternately. The light guiding body having such configuration can be obtained by shaping the back surface side of the light guiding body into the stepped shape (in other words, a plurality of stepped portions are formed).

Preferably the reflecting portions and the coupling portions are formed from the light incident portion to the outer edge of the light guiding body. That is, the edge of the reflecting portion positioned on the outermost side contacts the outer edge of the light guiding body. According to such structure, a light is generated from the light guiding body including the edge portion by an action of the reflecting portion in the front direction of the light guiding body. Therefore, such structure makes it easy to cause the front side of the light guiding body including the edge portion (outer periphery) to generate the light at a satisfactory brightness.

In order to lessen a brightness unevenness of the light emitted from the front of the light guiding body, it is preferable that a shape of the light guiding body should be designed in such a way that a distance between the front surface and the back surface of the light guiding body becomes shorter continuously or stepwise as the concerned portion goes away from the light incident portion. According to such design, a light outputting efficiency can be enhanced even in the area distant from the light source, and as a result the light can be emitted with a minor difference of brightness. Concretely, for example, as described above, the back surface of the light guiding body may be formed stepwise toward the outer edge of the light guiding body from the light incident portion.

An elongated portion being elongated to conceal the light source may be formed on a part of the light guiding body. The back surface of the elongated portion serves as are cursive reflection surface shaped into a predetermined shape. Thus, the elongated portion functions as the shielding member for the light source and the reflex reflector. The “reflex reflector” is the reflecting member to reflect a light being incident on this member in the incident direction. It is preferable that a layer made of the light reflecting material (reflecting layer) should be formed on the back surface of the elongated portion. If such configuration is employed, the light source can be shielded without fail and simultaneously a good retroreflection light can be generated. The reflecting layer can be formed by the deposition of metal material (aluminum, silver, chromium, or the like), the metal plating, the sputter, the pasting of a metal film, or the like, for example.

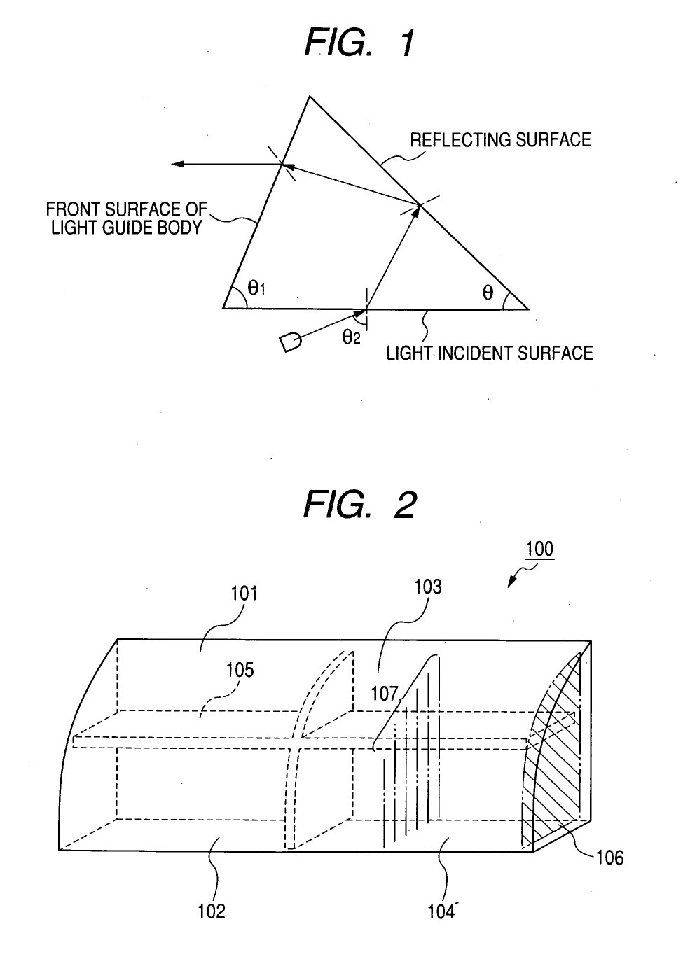

The light that reaches the reflecting portion out of the light being incident from the light incident portion is reflected by the boundary at the reflecting portion and is converted into the light that goes toward the front direction of the light guiding body. In this manner, the light that travels toward the front side of the light guiding body is generated by the reflecting portion that is formed by utilizing a part of the back surface. A shape, an angle, etc. of the surface defining each reflecting portion can be set arbitrarily by taking account of the traveling direction of the reflected light, the light distributing characteristic of the lighting assembly, etc. As shown in FIG. 1, a following relational expression can be derived.

θ=[180°−θ₁−sin⁻¹[{sin(90°−θ₁)/n}+sin⁻¹{(sin θ₂)/n}]/2 [Formula 1]

where θ is an angle between a plane defining the reflecting portion (reflecting plane) and a plane defining the light incident portion (light incident plane), θ₁ is an angle between the front of the light guiding body (design plane) and the light incident plane, θ₂ is an incident angle of the light to the light incident plane, and n is the refractive index.

An angle of the plane defining each reflecting portion can be designed based on this relational expression.

The coupling portion is an area where the light traveling in the front direction is never positively generated, unlike the reflecting portion. For example, the coupling portion is constructed by the plane that is parallel with the traveling direction of the light reaching there. When the substantial reflection is not generated by the coupling portion, generation of the light in the unintended direction (stray light) can be prevented and reduction of the brightness unevenness can be reduced.

It is preferable that a layer (reflecting layer) made of the light reflecting material should be formed on a surface of the reflecting portion. When such structure is employed, a light reflectance at the reflecting portion can be enhanced and the brightness (luminous intensity) of the lighting assembly can be improved. Also, when a regular reflection at the reflecting portion is increased by employing the metal material, or the like, the traveling direction of the reflected light can be made uniform. In this manner, it is preferable that the reflecting layer should be formed in view of the light distributing characteristic. The reflecting layer can be formed by the deposition of metal material (aluminum, silver, chromium, or the like), the metal plating, the sputter, the pasting of a metal film, or the like, for example.

When the lighting assembly of the present invention is observed from the outside, the reflecting portion formed on the back surface side can be seen through the front of the light guiding portion. Therefore, a shape of the reflecting portion becomes an important element constituting a design of the lighting assembly of the present invention. As a result, an improvement of the design property of the lighting assembly can be attained by giving a high design property to the reflecting portion. For example, when the reflecting layer is formed on the reflecting portion as described above, a texture peculiar to the used material can be provided. Concretely, when the reflecting layer is formed of the metal material such as aluminum, or the like, the reflecting portion is seen as a metallic texture via the light guiding portion and an unique design property can be created. Also, an unique design property can be given by applying a surface roughening to the surface of the reflecting portion or forming recesses in a predetermined pattern, in place of the reflecting layer or in addition to the reflecting layer.

Next, reflection and diffusion areas formed on the light guiding body will be explained with reference to FIG. 2 hereunder. In FIG. 2, a light guiding body 100 consisting of two blocks in the vertical and horizontal directions respectively, i.e., four blocks in total (first block 101, second block 102, third block 103, and fourth block 104) is schematically shown. In the present invention, a reflection and diffusion area 105 is formed in a boundary portion between two adjacent blocks. This reflection and diffusion area 105 functions as a barrier to the light, and the light leakage between the blocks (e.g., from the first block 101 to the second block 102) can be prevented. As shown in FIG. 2, it is preferable that the reflection and diffusion area 105 should be formed in all area except the neighborhood of the surface of the light guiding portion in the boundary portion between two adjacent blocks. The reflection and diffusion area provided over a wide area in this manner is effective in reducing an amount of light leakage from the adjacent block. It is preferable that the reflection and diffusion area should be provided as close as possible to the surface of the light guiding portion. For example, preferably the reflection and diffusion area should be formed in the position away from the surface of the light guiding portion by 0.5 mm to 1.0 mm.

The reflection and diffusion areas can be formed by the laser beam machining, or the like. Also, the reflection and diffusion areas can be formed by mixing fine bubbles (air). In the case of the laser beam machining, fine cracks are formed in desired areas. That is, the reflection and diffusion area formed by the laser beam machining has a set of fine cracks. According to the laser beam machining, the reflection and diffusion areas can be formed with high precision.

It is preferable that the reflection and diffusion areas having a multi-layered structure should be formed. Such reflection and diffusion areas have a high performance to block the light. According to the laser beam machining, the reflection and diffusion areas having such multi-layered structure can be formed easily.

A thickness of the reflection and diffusion areas (a length in the direction perpendicular to the boundary surface between two adjacent areas) is not particularly restricted as far as the satisfactory shielding effect can be produced. For example, the thickness is set to 0.5 mm to 1.0 mm.

In a preferable mode of the present invention, scattered reflection areas (a symbol 106 in FIG. 2) in addition to the reflection and diffusion areas are formed on the light guiding body. The scattered reflection area 106 is formed to continue from the front surface side of the light guiding body to the back surface side. This scattered reflection area 106 reflects diffusely the light reaching there. As a result, the light whose direction is different from that of the light being generated by the reflecting portion provided on the back surface side of the light guiding body is generated. Accordingly, the light guiding body can notify the luminous state in not only the front direction but also the side direction. In the example in FIG. 2, when the third block 103 and the fourth block 104 in the luminous state are observed from the obliquely above or the side, the scattered reflection area 106 looks like its luminous state.

A shape of the scattered reflection area 106 is not particularly restricted But it is preferable that the scattered reflection area 106 should be formed as a curved surface to cause the scattered reflection area to produce satisfactorily the above effect. In this case, the scattered reflection area may be shaped into various shapes such as a line shape, a circular shape, and the like, in addition to the plane. Also, the scattered reflection areas may be dotted, for example, the scattered reflection areas are formed in a dot-matrix fashion, or the like.

It is preferable that the scattered reflection area 106 should be formed on the edge portion of the block. This is because such a situation can be eliminated that a light guiding action in the block is affected largely by the scattered reflection area. Also, this is because a reduction in the design property caused due to the event that the scattered reflection area is viewed in the center or its neighborhood of the block can be prevented. In this case, formation of the scattered reflection area in the area other than the edge portion of the block is not precluded. That is, for example, as shown in FIG. 2, when the influence on the light guiding action is suppressed by employing a slit-like scattered reflection area 107, the dot matrix-like scattered reflection area, or the like, there is caused no problem in practical use even though the scattered reflection area is formed in the area other than the edge portion of the block.

Like the light diffusing area, the scattered reflection area can be formed by the laser beam machining, or the like. According to the laser beam machining, the scattered reflection area formed of a set of fine cracks can be formed easily with high accuracy. It is preferable that a single-layer scattered reflection area having a thin thickness (a width viewed from the front surface side of the light guiding body, i.e., a length in the lateral direction in FIG. 2) should be formed. This is because a degradation of the design property due to the fact that the scattered reflection area is observed when viewed from the front side should be suppressed. A thickness of the scattered reflection area is set to 0.05 mm to 0.1 mm, for example.

The number of scattered reflection areas formed in one block is not restricted to one. For example, the scattered reflection area may be formed on left and right edge portions of the block respectively. Also, the scattered reflection areas that continue to cross the boundary portion between two adjacent blocks may be formed.

A housing for housing the light source is fitted to the back surface side of the light guiding body. The connection of the housing can be performed by deposition, adhesion, or the like. In this case, for the reason that the connection portion between the light guiding body and the housing is hard to see and the design property is improved, preferably the deposition should be employed.

Next, constituent elements of the rear combination lamp of the present invention will be explained in detail hereinafter. The rear combination lamp of the present invention includes a tail/stop lamp portion and a turn lamp portion. The tail/stop lamp portion has a first lamp as a light source. The kind of the first lamp is not particularly restricted, but preferably the LED lamp should be employed. This is because the LED lamp has various advantages of small size, excellent vibration proof, excellent shock resistance, etc. The type of the first lamp is not particularly restricted, and various types such as shell type, SMD type, and the like may be employed. The first lamp may be constructed by a plurality of LED lamps.

In contrast, the turn lamp portion is provided in a position over the tail/stop lamp portion. The turn lamp portion has a second lamp as a light source. It is preferable that the second lamp should be formed of the LED lamp like the first lamp. Also, the second lamp may be constructed by a plurality of LED lamps.

The housing houses the first lamp and the second lamp therein. The tail/stop lamp portion and the turn lamp portion are in communication with each other in the housing. The material of the housing is not particularly restricted, and can be decided in light of moldability, shock resistance, weather resistance, and the like. For example, an ABS resin, a polypropylene (PP) resin, and the like can be employed. The housing has a first vent hole near the first lamp. In this case, the wording “has a first vent hole near the first lamp” means a situation that a center of the first vent hole exists in a circular area with a radius of about 10 mm, preferably a circular area with a radius of about 5 mm, around a position where a distance between a center of the first lamp and the housing is shortest. A shape of the first vent hole is not particularly restricted, and a slit-like shape, a circle-like shape, an elliptic-like shape, or the like may be employed. Among them, the slit-like shape is preferable. This is because, if the first vent hole is shaped into the slit-like shape, a speed of external air that flows into the housing through the first vent hole is sped up and an effect of introducing the external air into the housing is enhanced. The shape of the first vent hole is set to a width of 8 mm to 10 mm and a length of 8 mm to 10 mm, preferably a width of 3 mm to 5 mm and a length of 8 mm to 10 mm, for example. In this case, a plurality of holes may be used as the first vent hole. When a plurality of lamps are used as the first lamp, the first vent holes may be provided on a one-to-one basis. Of course, one first vent hole may be provided to correspond to a plurality of lamps.

The housing has the second vent hole near the second lamp. In this case, the wording “has the second vent hole near the second lamp” means a situation that a center of the second vent hole exists in a circular area with a radius of about 15 mm, preferably a circular area with a radius of about 8 mm, around a position where a distance between a center of the second lamp and the housing is shortest. It is preferable that an opening portion of the second vent hole should have an opening area larger than that of the first vent hole. For example, the opening portion of the second vent hole is set to a circle with a diameter of 8 mm to 15 mm, preferably a circle with a diameter of 8 mm to 10 mm. When a plurality of lamps are used as the second lamp, the second vent holes may be provided on a one-to-one basis. Of course, one second vent hole may be provided to correspond to a plurality of lamps. The second vent hole may also be used as the harness hole. If this structure is employed, there is no necessity to provide the harness hole separately. It is preferable that the second vent hole should be provided in a position over the second lamp. This is because, if this structure is employed, a heat of the second lamp is discharged easily together with an air exhausted from the second vent hole and thus a cooling effect can be enhanced.

A waterproof process may be applied to the first vent hole and the second vent hole. As the waterproof process, the well-known approaches such as a coating using an air-permeable waterproof film, a water-repellent mesh, and the like can be employed.

In one mode of the present invention, a lens for introducing a light of the first lamp via the first light incident portion provided to the lower end and emitting the light from the front is provided to the tail/stop lamp portion. A thickness of the lens is thinned continuously or stepwise as a distance is remote from the lower end. Accordingly, as the result that a light outputting efficiency can be enhanced even in the area being distant from the first lamp, it can be prevented that brightness unevenness is generated in the light being emitted from the front. Also, a plurality of reflecting portions and coupling portions are formed on the back surface side of the lens to be connected alternately in the direction that goes away from the lower edge. The reflecting portion herein reflects the light being introduced and reached there by its boundary, and generates a light in the direction toward the front surface. In this configuration, a light of the first lamp is introduced into the lens and then is reflected by a plurality of reflecting portions connected via the coupling portions. This resultant light is emitted from the front of the lens. As the result that a light guiding action of the lens and a reflecting action of a plurality of reflection portions are utilized, the light diffuses throughout the lens including the edge portion and thus the light can be emitted from all over the front surface of the lens including the edge portion. In this case, the reflecting portion on the back surface of the lens is formed by applying the light reflecting process to the back surface of the lens. As the light reflecting process, for example, the deposition of metal material (aluminum, silver, chromium, or the like), the metal plating, the sputter, the pasting of a metal film, or the like may be employed otherwise, an application of a surface roughening or formation of recesses in a predetermined pattern may be employed.

It is preferable that the first lamp should have a heat sink with rib-like fins on the back surface side. In this case, it is preferable that the first lamp should be arranged such that the light emitting side of the first lamp opposes to the lower edge surface of the lens and the fins of the heat sink are positioned in parallel with the longitudinal direction of the lens. With this configuration, the fins of the heat sink act as a guide to flow the external air flowing in through the first vent hole from the front side of the lens to the rear side in the tail/stop lamp portion. Accordingly, the external air flowing in the housing through the first vent hole can flow smoothly from the tail/stop lamp portion to the outside via the turn lamp portion and the second vent hole, and thus a cooling effect of the overall equipment can be enhanced. In such arrangement, it is preferable that the first vent hole of the housing should be provided near the first lamp and in front of the first lamp. This is because the external air flowing in from the first vent hole is easy to touch the heat sink of the first lamp and therefore the cooling effect can be much more enhanced.

In contrast, it is preferable that, when the first lamp is arranged on the back surface side of the lens such that the light emitting side opposes to the back surface of the lens, the fins of the heat sink should be set in parallel with the vertical direction of the lens. In such structure, the fins of the heat sink serve as the guide to direct the air flowing in through the first vent hole in the tail/stop lamp portion from the lower side of the lens to the upper side. Therefore, the air flowing into the housing through the first vent hole can flow smoothly from the tail/stop lamp portion to the outside via the turn lamp portion and the second vent hole, so that a cooling effect of the overall equipment can be enhanced. In such arrangement, it is preferable that the second vent hole of the housing should be provided near the first lamp and at the back of the first lamp. This is because the external air flowing in from the first vent hole is easy to touch the heat sink of the first lamp and therefore the cooling effect can be further enhanced.

A light scattering agent may be contained in the lens. Thus, a diffusion of light in the lens is increased, and a light having a good balance of brightness is emitted from the lens front. As the light scattering agent, glass having a predetermined particle size, metal such as aluminum, or the like, resin having a refractive index different from the lens, silica, and the like, for example, can be employed.

### First Embodiment

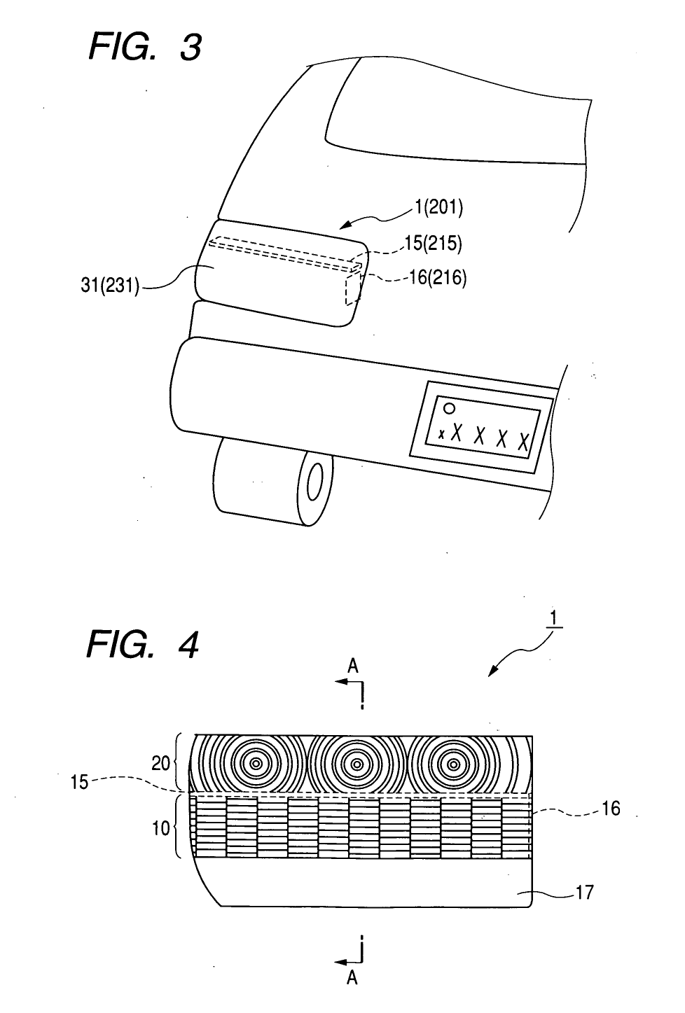

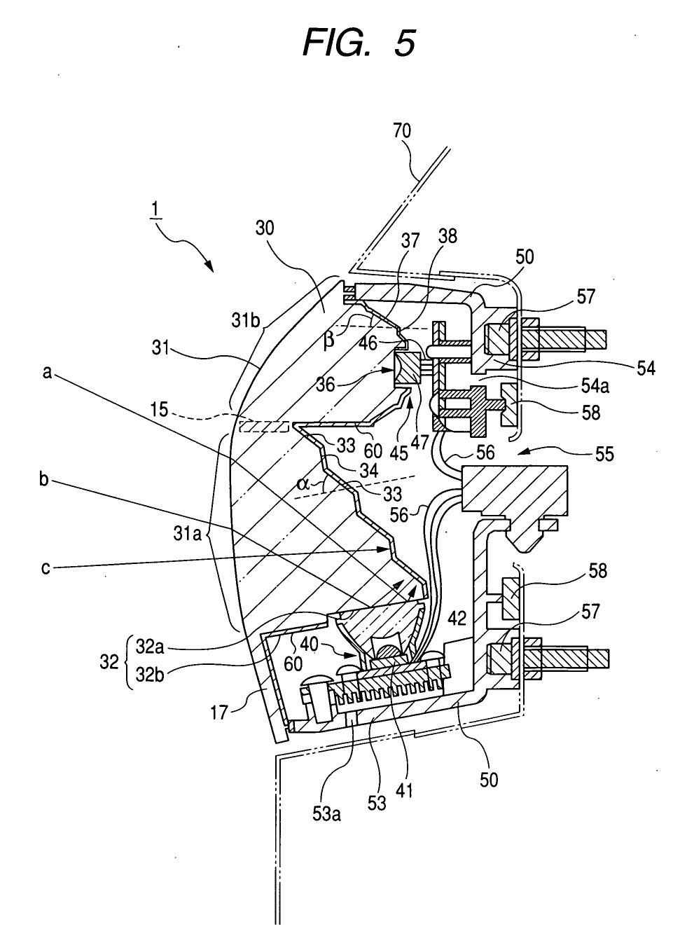

A configuration of the present invention will be explained in detail with reference to the embodiments hereunder. FIG. 3 is a perspective view showing a car body rear portion to which a rear combination lamp 1 as a first embodiment is provided. FIG. 4 is a front view of the rear combination lamp 1, and FIG. 5 is a sectional view taken along an V-V line position in FIG. 4. The rear combination lamp 1 has a tail/stop lamp portion 10 for giving a tail lamp display and a stop lamp display, and a turn lamp portion 20 for giving a turn signal display.

As shown in FIG. 5, the rear combination lamp 1 when classified roughly is constructed by a lens 30, two types of LED units (a first LED unit 40 and a second LED unit 45), and a housing 50. In the rear combination lamp 1, a light emitted from a lens front 31 of the lens 30 irradiates directly the outside. That is, the lens front 31 of the lens 30 constitutes an outer surface of the rear combination lamp 1, and as a result the peculiar stereoscopic effect/crystal feeling is produced.

The lens 30 is made of an acrylic resin whose refractive index is about 1.5, and a thickness of the thickest portion (a length between the front surface and the back surface) is about 35 mm. In this manner, the thick lens is employed. The lens front 31 of the lens 30 constitutes a convex surface that curves gently all over the whole surface. A radius of curvature of the convex surface is 400 mm to 600 mm. In contrast, as explained in detail herein after, a lens lower portion constituting the tail/stop lamp portion 10 and a lens upper portion constituting the turn lamp portion 20 are different in shape on the back surface side of the lens 30.

In this case, the material of the lens is not particularly restricted, and any lens made of the light propagating material whose refractive index is about 1.4 to 1.8 may be employed. Concretely, in addition to the acrylic resin used in this embodiment, a polycarbonate resin, an epoxy resin, a glass, and the like can be employed.

A lower surface 32 of the lens lower portion is divided into two sections, i.e., a first light incident surface 32a and a light non-incident surface 32b, at the step formed on its almost center portion. The first LED unit 40 opposes to the first light incident surface 32a. Since the first light incident surface 32a and the lens front 31 are constructed such that they can be separated mutually, a thickness of the lens 30 can be adjusted adequately. That is, flexibility in design of the lens 30 can be enhanced. In this case, the first light incident surface 32a is shaped into a smooth plane to enhance a light introducing efficiency. In this embodiment, three first LED units 40 are aligned at equal intervals along the longitudinal direction of the lens (the vertical direction to a surface of the sheet of FIG. 5). The first LED unit 40 is an LED unit in which an LED lamp 41 for emitting a red light is built, and emits a parallel light by an action of a lens 42 provided over the LED lamp 41.

The back surface side of the lens lower portion is shaped into a regular stepwise shape upwardly from the neighborhood of the first light incident surface 32a. Thus, a first reflecting portion 33 and a first coupling portion 34 are connected alternately. In this manner, a simple and small structure can be implemented by utilizing a part of the lens 30.

The first reflecting portion 33 acts as an area that reflects a light from the first LED unit 40 by its boundary to generate the light toward the lens front 31. The first reflecting portion 33 constitutes a convex surface (reflection surface) inclined at a predetermined angle to the first light incident surface 32a. An angle between the convex surface and the first light incident surface 32a (angle α in FIG. 5) is set to about 40° to 50° in section.

In contrast, the surface of the first coupling portion 34 is almost perpendicular to the first light incident surface 32a in section, and does not take a positive reflecting action toward the lens front 31 unlike the first reflecting portion 33. A shape and an angle of the first reflecting portion 33 are set by taking the light distributing characteristic of the tail/stop lamp portion 10 into consideration. In this case, the first reflecting portions 33 are constructed such that the light from the first LED unit 40 irradiates all first reflecting portions 33. Also, the shapes and the angles of all the first reflecting portions 33 are not always set identically. The first coupling portion 34 can be discussed similarly.

As described above, because the back surface side is shaped stepwise, the lens lower portion is formed thickest (about 35 mm) in the position near the first light incident surface 32a and becomes regularly thinner as it becomes more distant from the first light incident surface 32a. In this case, a height of the lens lower portion (a height apart from a projection portion 17 explained hereinafter) is about 50 mm.

The front surface side of the lens lower portion projects downward like a flat plate to conceal the first LED unit 40. The back surface of the projection portion 17 is shaped into a predetermined shape to constitute a retroreflection surface. Thus, the projection portion 17 functions as a reflex reflector. In this manner, the reflex reflector also used as the shielding member is formed by using a part of the lens 30. A reflecting layer 60 is formed on the back surface of the projection portion 17 by depositing the aluminum material, as described later. As a result, the first LED unit 40 is shielded without fail, good generation of a retroreflection light is accelerated, and a texture of the projection portion 17 becomes similar to other portions when viewed from the front surface side. Thus, such a situation can be prevented that the first LED unit 40 is seen when viewed from the front surface side.

On the back surface side of the lens upper portion, a light incident portion (a second light incident portion 36) for the second LED unit 45 is formed in a center position in the vertical direction. The second light incident portion 36 is a concave portion in which a light emergent portion of the second LED unit 45 is involved. A surface of the concave portion constituting the second light incident portion 36 is flat and smooth, so that a light introducing efficiency is enhanced. In this embodiment, three second LED units 45 are aligned at equal intervals along the lateral direction (the vertical direction to a surface of the sheet of FIG. 5) of the lens 30, and correspondingly the second light incident portion 36 is formed at three locations at equal intervals. The second LED unit 45 is an LED unit in which an LED lamp 46 for emitting an amber color light is built. The second LED unit 45 generates a light in the lateral direction (360° omnidirectional) by an action of a lens 47 provided over the LED lamp 46.

The back surface side of the lens upper portion is shaped into a regular stepwise shape from the second light incident portion 36 as a center to the periphery. Thus, a second reflecting portion 37 and a second coupling portion 38 are connected alternately. The second reflecting portion 37 acts as an area that reflects a light from the second LED unit 45 by its boundary to generate the light toward the lens front 31. The second reflecting portion 37 is formed of the surface whose angle to a center axis of the second LED unit 45 (angle β in FIG. 5) is set to about 30° to 50° in section.

In contrast, the second coupling portion 38 is formed of the surface whose angle to a center axis of the second LED unit 45 is set to almost 90°, and does not take a positive reflecting action toward the lens front 31 unlike the second reflecting portion 37.

A shape and an angle of the second reflecting portion 37 are set by taking the light distributing characteristic of the turn lamp portion 20. Also, the shapes and the angles of all the second reflecting portions 37 are not always set identically. The second coupling portion 38 can be discussed similarly.

As described above, because the back surface side is shaped stepwise, the lens upper portion is formed thickest (about 30 mm) in the position near the second light incident portion 36 and becomes regularly thinner as it becomes more distant from the second light incident portion 36. In this case, a height of the lens upper portion is about 35 mm.

A light reflecting process is applied to the back surface side of the lens 30 except the first light incident surface 32a, the second light incident portion 36, and the housing 50. Concretely, a reflection layer 60 is formed by depositing the aluminum material. Because the reflection layer 60 is formed, a reflection efficiency of the first reflecting portion 33 and the second reflecting portion 37 can be improved and the traveling direction of the reflected light can be made uniform. Also, because the reflection layer 60 is seen when the lens 30 is viewed from the lens front side, a metallic texture is given.

A reflection and diffusion area 15 that continues in the lateral direction (the vertical direction to a surface of the sheet of FIG. 5) of the lens 30 is formed on the boundary portion between the lens upper portion and the lens lower portion (FIG. 3, FIG. 5). In the rear combination lamp 1, this reflection and diffusion area 15 functions as the barrier to the light and prevents the light leakage from the tail/stop lamp portion 10 to the turn lamp portion 20 and also the light leakage in the opposite direction.

The reflection and diffusion area 15 is formed by the laser beam machining, and has a multi-layered structure laminated in the vertical direction of the lens 30. For example, the reflection and diffusion area having two to eight layers may be formed. Each layer is formed of a set of fine cracks. A thickness of the reflection and diffusion area 15 (a length in the vertical direction) is about 5 mm. As shown in FIG. 5, the reflection and diffusion area 15 is formed close to the surface of the lens 30. Concretely, a distance between the reflection and diffusion area 15 and the lens front is about 3 mm, and a distance between the reflection and diffusion area 15 and the lens back surface is about 3 mm. In this manner, the light leakage can be suppressed to the lowest minimum by providing the reflection and diffusion area 15 that covers the boundary portion widely.

In contrast, in the lens lower portion shown in FIG. 3 and FIG. 4, a planar scattered reflection area 16 is formed on the right edge portion when viewed from the front side. The scattered reflection area 16 is formed by the laser beam machining and is formed of a set of fine cracks. In this case, the scattered reflection area 16 has a single-layer structure unlike the reflection and diffusion area 15, and has a thickness (a length in the lateral direction) of about 1 mm.

The housing 50 is made of a synthetic resin, and has a fitting portion 53 for the first LED unit 40 and a fitting portion 54 for the second LED unit 45. A plurality of heat radiation holes 53a are formed in a fitting portion 53. An effective heat radiation can be attained when an air warmed by the heat generated by the first LED unit 40 is emitted to the outside through the heat radiation holes 53a or when a cooled air is let in the housing 50 through the heat radiation holes 53a. Thus, an overheat of the first LED unit 40 and the thermal influence on the surrounding members can be prevented. In this case, as the measure to heat generation from the second LED unit 45, similarly heat radiation holes 54a are formed in a fitting portion 54.

The housing 50 is fitted to the back surface side of the lens 30 by heat-plate depositing the edge portion of the housing 50 and the edge portion of the lens back surface side. Wire harnesses 56 are connected to a substrate for the first LED unit 40 and a substrate for the second LED unit 45 through a through hole 55 provided in the housing 50. The rear combination lamp 1 is secured to a car body 70 by screws 57 and seat packings 58.

Next, a lighting mode of the rear combination lamp 1 will be explained hereunder. First, when the tail lamp display is given, the first LED unit 40 is lightened at a low brightness in response to an input signal from the vehicle side. A parallel light emitted from the first LED unit 40 is introduced into the lens lower portion via the first light incident surface 32a. The introduced light reaches the first reflecting portion 33, is reflected there, and is converted into a light toward the lens front 31. The light generated in this way is radiated from the front of the lens lower portion (a first light emitting area 31a).

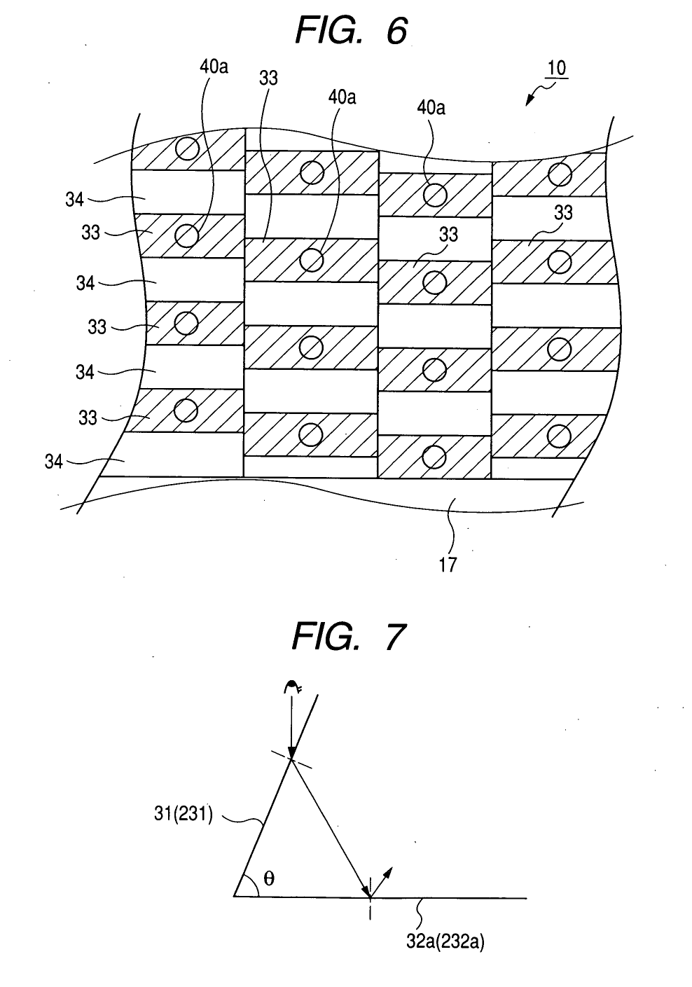

A state of the tail/stop lamp portion 10 in emitting a light is shown schematically in FIG. 6. It can be seen that an area from which the light is emitted (the first reflecting portion 33) and an area from which the light is not emitted (the first coupling portion 34) appear alternately in the vertical direction. A mirror image 40a of the first LED unit 40 can be seen in each first reflecting portion 33. Meanwhile, the first reflecting portion 33 constituting a convex surface functions as a convex mirror, and covers a wide area. Accordingly, a whole mirror image of the first LED unit 40 can be seen on each first reflecting portion 33. That is, all first reflecting portions 33 show a complete mirror image of the first LED unit 40, so that the design property can be improved.

As can be seen from FIG. 6, the first reflecting portions 33 are connected in the lateral direction while displacing upwardly by every distance equivalent to a half of one first reflecting portion 33. With this structure, a size of the stepped portions on the lens back surface side can be reduced and thus a molding of the lens 30 can be facilitated.

Here, the thick lens can be employed and also the light can be generated toward the lens front 31 by a plurality of first reflecting portions 33 being connected via the first coupling portions 34. Therefore, the front portion of the lens lower portion except the projection portion 17 serving as the reflex reflector emits the light as a whole.

By the way, a quantity of light reaching the first reflecting portion 33 in the position away from the first LED unit 40 is smaller than a quantity of light reaching the first reflecting portion 33 in the position close to the first LED unit 40. However, as understood from the above explanation, a distance of the first reflecting portion 33 in the position away from the first LED unit 40 to the lens front 31 is short and thus the reflected light generated there is irradiated effectively from the first light emitting area 31a. In this way, a reduction of a quantity of light due to the distance from the first LED unit 40 can be canceled by an increase of a light utility factor, and as a result a brightness of the light emitted from the first light emitting area 31a can be uniformized. In this case, a uniformization of a luminance brightness can be achieved by such a structure that the light from the first LED unit 40 can be input into all first reflecting portions 33.

A part of the light propagating through the lens lower portion travels toward the lens upper portion. In the rear combination lamp 1, the reflection and diffusion area 15 acts as the barrier to this light. That is, the light traveling toward the lens upper portion is shut off by the reflection and diffusion area 15. Accordingly, the light leakage to the turn lamp portion 20 is prevented, and a parting, i.e., a boundary between the luminous area and the non-luminous area on the lens front 31 becomes clear, so that the luminous display that is excellent in the design property and the visibility can be provided. In this case, as described above, because the reflection and diffusion area 15 is constructed by the multi-layered structure, a high light blocking effect can be achieved.

In contrast, a part of the light propagating through the lens lower portion reaches the scattered reflection area 16 and is diffusedly reflected. Accordingly, when the user looks at the rear combination lamp 1 from obliquely above or the side, such user can watch the light caused due to the scattered reflection area 16 (i.e., planar light emission). In this manner, the luminous display with a wide view angle is given. Here, because the scattered reflection area 16 is formed thin and its forming position is set to the edge portion of the lens lower portion, it is prevented that the scattered reflection area 16 becomes conspicuous when viewed from the front, and at the same time an influence on the light guiding action is reduced.

In the tail/stop lamp portion 10, the thick lens 30 is employed as described above, the first LED unit 40 is not arranged on the back surface side of the lens lower portion (the light source is arranged in the position facing to the side edge surface and/or the lower edge surface of the lens), and this lens 30 is designed such that a light incident directly on the first light incident surface 32a out of the external light incident from the lens front 31 is totally reflected by the boundary of the first light incident surface 32a portion. Thus, it can be prevented that the first LED unit 40 is watched directly from the outside through the lens 30. In other words, when the lamp portion 10 is viewed from an a position or a b position in FIG. 5, the first LED unit 40 is not viewed because of the total reflection caused by the lens front 31 or the first light incident surface 32a. When viewed from a c position, the reflection layer 60 is seen, and the presence of the first LED unit 40 cannot be seen like the case where the lamp portion 10 is viewed from an a position or a b position.

Since the elongated portion 17 functions as the shielding member for the first LED unit 40, as described above, in addition to the action of the above lens, the first LED unit 40 cannot be seen directly from the front surface side at all. In this manner, the configuration, although being simple, succeeded in concealing the presence of the first LED unit 40 surely, and thus the lighting assembly having excellent design property and producing an unexpected feeling can be constructed.

In order to generate the total reflection mentioned herein, as shown in FIG. 7, an angle θ between the lens front 31 and the first light incident surface 32a must satisfy a predetermined condition, i.e., a relational expression (applied when the first light incident surface 32a is a planar surface) given as follows.

θ>2 sin⁻¹(1/n) [Formula 2]

where n is the refractive index of the lens.

In case the lens 30 is designed to satisfy the above condition over the whole lens lower portion, when the lamp portion 10 is viewed through the lens front 31 in the first LED unit 40 direction (i.e., the first light incident surface 32a direction), the first LED unit 40 cannot be seen irrespective of a view point position. That is, the first LED unit 40 cannot be seen directly through the lens front 31. In this manner, it is preferable that the presence of the first LED unit 40 should be perfectly concealed. However, when such a situation is taken into consideration that a range of a viewing position of a watcher is limited in using the rear combination lamp 1 (for example, the rear combination lamp 1 is never seen from the a position in FIG. 5 in normal use), it is possible to say that there is caused no problem in practical use unless a part of the lens front 31 (e.g. an upper edge portion of the lens lower portion) satisfies the above condition. As a result, the rear combination lamp 1 may be constructed such that an angle θ between the lens front 31 and the first light incident surface 32a satisfies a predetermined condition, i.e., a following relational expression.

θ>2 sin⁻¹(1/n)−10° [Formula 3]

An area through which the first LED unit 40 is seen directly from the outside may be formed positively on the lens front 31. According to this configuration, an unexpected feeling can be aroused in such a way that the first LED unit 40 appears suddenly depending on a change of the viewing position or the first LED unit 40 being watched is concealed suddenly.

In order to cause easily the total reflection, preferably the first light incident surface 32a should be formed as a flat smooth surface. The first light incident surface 32a when formed as a flat smooth surface can introduce effectively the light from the first LED unit 40 into the lens 30 and can set the traveling direction of the introduced light uniformly. In this manner, it is also preferable that the first light incident surface 32a is formed as a flat smooth surface, from respects of a light utility factor and a light distribution control.

In this embodiment, a good distribution of the light introduced into the lens 30 can be realized by forming the first light incident surface 32a as a flat surface. A shape of the first light incident surface 32a is not limited to the flat plane. For example, the first light incident surface 32a may be constructed by any curved surface. Also, the first light incident surface 32a may be constructed by combining various surfaces of different profiles.

The stop lamp display can be lightened in the similar lightening mode to the tail lamp display, except that the light having a higher brightness than the first light emitting area 31a can be obtained as the result that the first LED unit 40 is lightened in high brightness.

In providing the turn signal display, the second LED unit 45 is lightened in response to an input signal from the vehicle side, and an amber color light is introduced into the lens upper portion via the second light incident portion 36 provided to the lens upper portion. Like the case of the tail lamp display, this introduced light is converted into the light traveling toward the lens front 31 direction by the second reflecting portion 37 and thus the front portion (second light emitting area 31b) of the lens upper portion emits the light, so that the turn signal display is given. Also, like the tail/stop lamp portion 10, because a light utility factor in the area that is away from the second LED unit 45 is increased, a brightness of the light emitted from the second light emitting area 31b can be uniformized. In this case, in the lightening state of the turn lamp portion 20 similar to the lightening state of the tail/stop lamp portion, the reflection and diffusion area 15 exhibits the good blocking effect to prevent the light leakage. As a result, the luminous mode with the high design property and the high visibility can be attained.

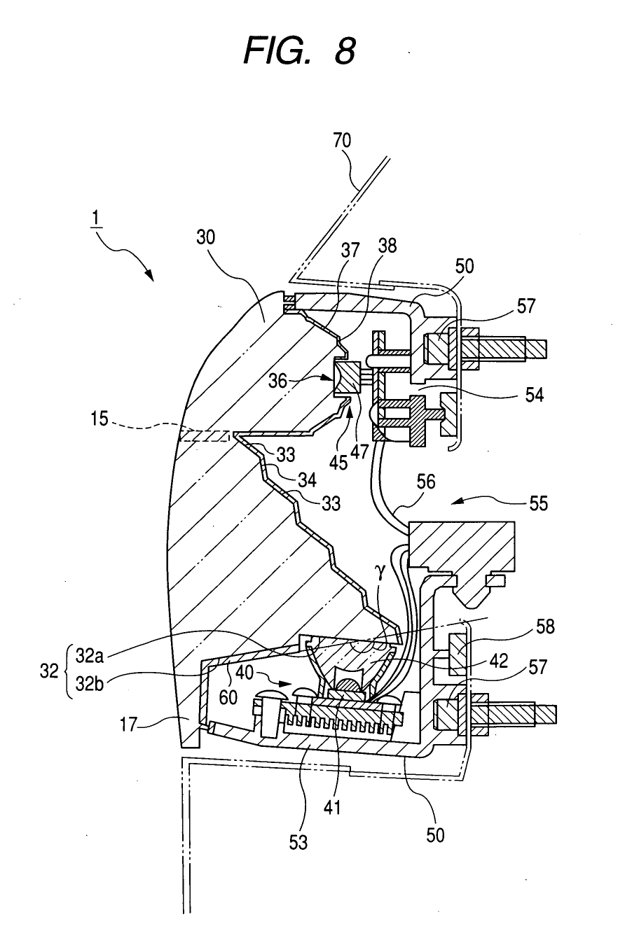

In this embodiment, the first light incident surface 32a and the light non-incident surface 32b of the lens 30 are formed in parallel with each other. As shown in FIG. 8, the first light incident surface 32a may be inclined with respect to the light non-incident surface 32b. In an example in FIG. 8, the first light incident surface 32a is inclined in the direction to reduce an angle between the first light incident surface 32a and the light non-incident surface 32b. An angle γ between the first light incident surface 32a and the light non-incident surface 32b is set to about 160°. This structure is effective in preventing such a situation that the first LED unit 40 is viewed directly through the lens front 31. That is, an area through which the first LED unit 40 cannot be seen directly can be enlarged by inclining the first light incident surface 32a. Thus, a margin in design of the lens front 31 is enhanced, and a reduction in thickness of the lens 30, and the like can be implemented. Also, the inclined arrangement of the first light incident surface 32a is effective in increasing the number and the area of the first reflecting portions 33. An increase of the reflecting portion contributes to a uniformization of the brightness. Here, an angle between the first light incident surface 32a and the light non-incident surface 32b is not particularly restricted, but normally the angle is set to 120° to 180°.

By the way, when the light is irradiated onto the rear combination lamp 1 from the outside, for example, the light is irradiated from the headlight of the car behind, or the like, the elongated portion 17 formed as a part of the lens 30 functions as the reflex reflector to generate the retroreflection light. Thus, the person outside can be informed of the presence of the vehicle. In this manner, the additional function as well as the essential function (the lamp display) can be shown. Also, since the reflex reflector is provided as not a separate body but a part of the lens, the rear combination lamp 1 is excellent in the compactification and the design property.

### Second Embodiment

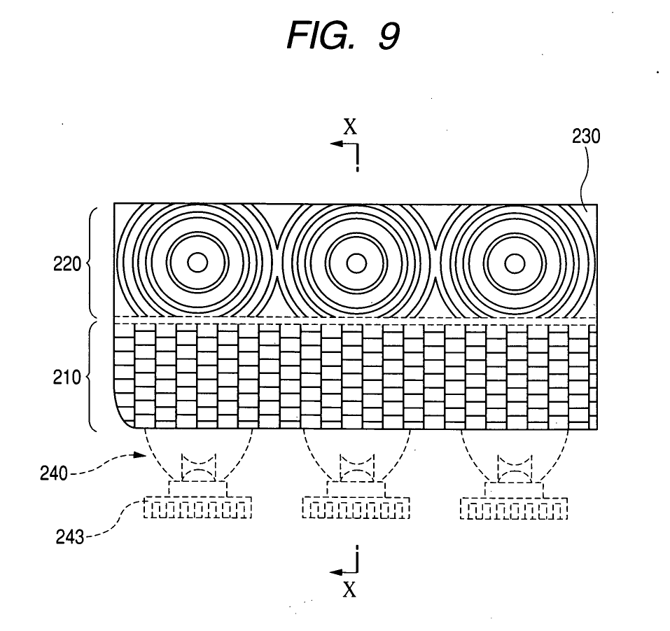

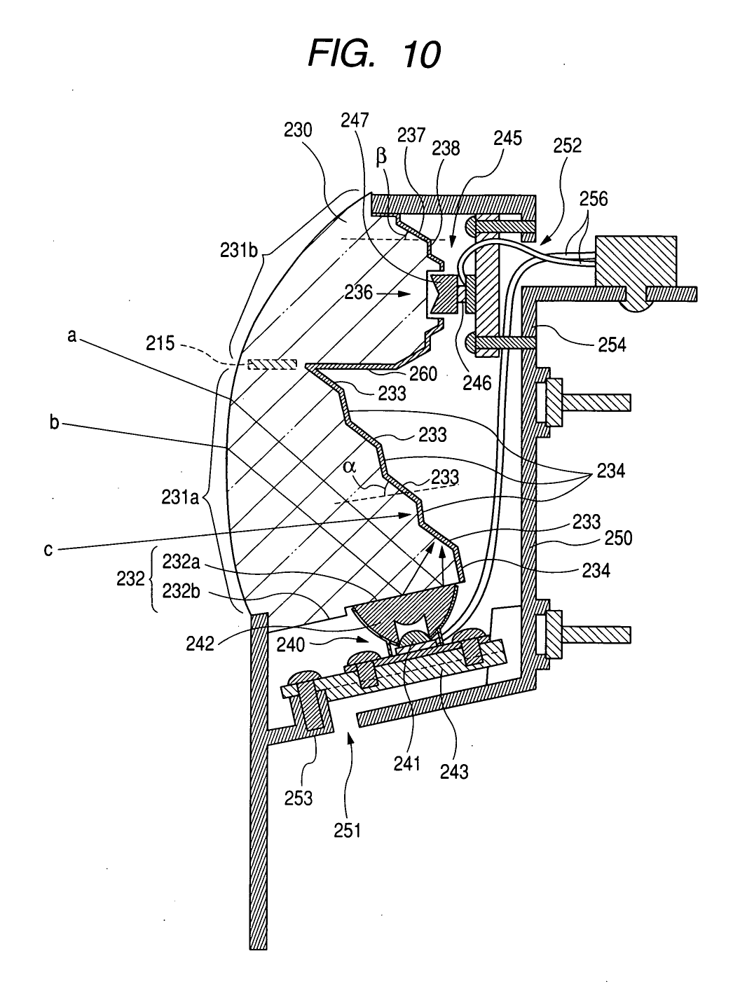

A perspective view of a car body rear portion to which a rear combination lamp 201 as the second embodiment of the present invention is provided is shown in FIG. 3 (similar to the first embodiment). A front view of the rear combination lamp 201 is shown in FIG. 9, and a sectional view taken along an X-X line in FIG. 9 is shown in FIG. 10. The rear combination lamp 201 has a tail/stop lamp portion 210 for giving a tail lamp display and a stop lamp display, and a turn lamp portion 220 for giving a turn signal display.

As shown in FIG. 10, the rear combination lamp 201 when classified roughly is constructed by a lens 230, two types of LED units (a first lamp 240 and a second lamp 245), and a housing 250. In the rear combination lamp 201, a light emitted from a lens front 231 of the lens 230 irradiates directly the outside. That is, the lens front 231 of the lens 230 constitutes an outer surface of the rear combination lamp 201, and as a result the peculiar stereoscopic effect/crystal feeling is produced.

The housing 250 is made of a synthetic resin, and has a first vent hole 251, a second vent hole 252, a fitting portion 253 for the first lamp 240, and a fitting portion 254 for the second lamp 245. The housing 250 is fitted to the back surface of the lens 230 by heat-plate depositing the edge portion of the housing 250 to the edge portion of the lens 230 on the back surface side. Thus, the first lamp 240 and the second lamp 245 are housed between the lens 230 and the housing 250 in a state that mutual fitting areas are communicated with each other. The first vent hole 251 is provided in front of the fitting area of the first lamp 240 (the front direction of the lens 230). The first vent hole 251 has a slit-like shape of 3 mm width and 8 mm length, and is formed over the fitting areas of three first lamps 240. The second vent hole 252 is provided near the second lamp 245 in the housing 250. Wire harnesses 256 are connected to a substrate for the first lamp 240 and a substrate for the second lamp 245 through the second vent hole 252.

The first lamp 240 has a heat sink 243 having rib-like fins. The heat sink 243 is made of aluminum, and is fitted to the back surface side of the first lamp 240. The fins of the heat sink 243 are formed in parallel with the longitudinal direction (the lateral direction of a sheet in FIG. 10) of the lens 230.

The lens 230 is made of an acrylic resin whose refractive index is about 1.5, and a thickness of the thickest portion (a length between the front surface and the back surface) is about 35 mm. A lower portion of the lens functions as a lens of the tail/stop lamp portion 210, and an upper portion of the lens functions as a lens of the turn lamp portion 220. That is, the lens 230 is a lens in which two types of lenses are formed integrally. The lens front 231 of the lens 230 constitutes a convex surface that curves gently all over the whole surface. A radius of curvature of the convex surface is 400 mm to 600 mm. In contrast, as explained in detail herein after, the lower portion and the upper portion of the back surface side of the lens 230 are different in shape. In this case, the material of the lens is not particularly restricted, and any lens made of the light propagating material whose refractive index is about 1.4 to 1.8 may be employed. Concretely, in addition to the acrylic resin used in this Example, a polycarbonate resin, an epoxy resin, a glass, and the like can be employed.

As shown in FIG. 10, a lower surface 232 of the upper portion of the lens 230 is divided into a first light incident surface 232a positioned on the back surface side and a light non-incident surface 232b positioned on the front side at its almost center portion. The first lamp 240 opposes to the first light incident surface 232a. Since the first light incident surface 232a and the lens front 231 are constructed such that they can be separated mutually, a thickness of the lens 230 can be adjusted adequately. That is, flexibility in design of the lens 230 can be enhanced. In this case, the first light incident surface 232a is shaped into a smooth plane to enhance a light introducing efficiency. In this embodiment, three first lamps 240 are aligned at equal intervals along the longitudinal direction of the lens (the vertical direction to a surface of the sheet of FIG. 10). The first lamp 240 is an LED unit in which a red LED lamp 241 for emitting a red light is built, and emits a parallel light by an action of a lens 242 provided over the LED lamp 241.

The back surface side of the lens lower portion is shaped into a regular stepwise shape upwardly from the neighborhood of the first light incident surface 232a. Thus, a first reflecting portion 233 and a first coupling portion 234 are connected alternately. In this manner, a simple and small structure can be implemented by utilizing a part of the lens 230.

The first reflecting portion 233 acts as an area that reflects a light from the first lamp 240 by its boundary to generate the light toward the lens front 231. The first reflecting portion 233 constitutes a convex surface (reflection surface) inclined at a predetermined angle to the first light incident surface 232a. An angle between the convex surface and the first light incident surface 232a (angle α in FIG. 10) is set to about 40° to 50° in section.

In contrast, the surface of the first coupling portion 234 is almost perpendicular to the first light incident surface 232a in section, and does not take a positive reflecting action toward the lens front 231 unlike the first reflecting portion 233. A shape and an angle of the first reflecting portion 233 are set by taking the light distributing characteristic of the tail/stop lamp portion 210 into consideration. In this case, the first reflecting portions 233 are constructed such that the light from the first lamp 240 irradiates all first reflecting portions 233. Also, the shapes and the angles of all the first reflecting portions 233 are not always set identically. The first coupling portion 234 can be discussed similarly.

As described above, because the back surface side is shaped stepwise, the lower portion of the lens 230 is formed thickest (about 35 mm) in the position near the first light incident surface 232a and becomes regularly thinner as it becomes more distant from the first light incident surface 232a. In this case, a height of the lens lower portion (a height apart from a projection portion 217 explained hereinafter) is about 50 mm.

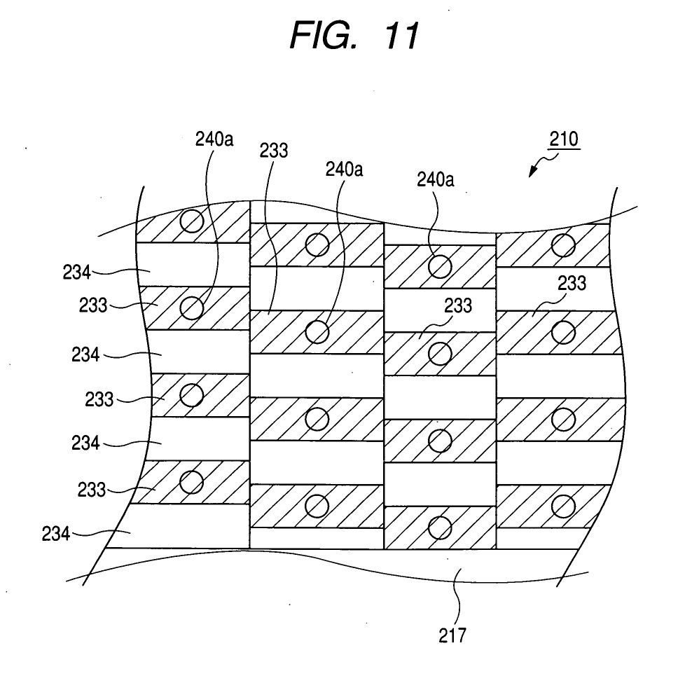

On the back surface side of the lens upper portion, a light incident portion (a second light incident portion 236) for the second lamp 245 is formed in a center position in the vertical direction. The second light incident portion 236 is a concave portion in which a light emergent portion of the second lamp 245 is involved. A surface of the concave portion constituting the second light incident portion 236 is flat and smooth, so that a light introducing efficiency is enhanced. In this embodiment, three second lamps 245 are aligned at equal intervals along the lateral direction (the vertical direction to a surface of the sheet of FIG. 11) of the lens 230, and correspondingly the second light incident portion 236 is formed at three locations at equal intervals. The second lamp 245 is an LED unit in which an LED lamp 246 for emitting an amber color light is built. The second lamp 245 generates a light in the lateral direction (360° omnidirectional) by an action of a lens 247 provided over the LED lamp 246.

The back surface side of the lens upper portion is shaped into a regular stepwise shape from the second light incident portion 236 as a center to the periphery. Thus, a second reflecting portion 237 and a second coupling portion 238 are connected alternately. The second reflecting portion 237 acts as an area that reflects a light from the second lamp 245 by its boundary to generate the light toward the lens front 231. The second reflecting portion 237 is formed of the surface whose angle to a center axis of the second lamp 245 (angle β in FIG. 10) is set to about 30° to 50° in section.

In contrast, the second coupling portion 238 is formed of the surface whose angle to a center axis of the second lamp 245 is set to almost 90°, and does not take a positive reflecting action toward the lens front 231 unlike the second reflecting portion 237.

A shape and an angle of the second reflecting portion 237 are set by taking the light distributing characteristic of the turn lamp portion 220. Also, the shapes and the angles of all the second reflecting portions 237 are not always set identically. The second coupling portion 238 can be discussed similarly.

As described above, because the back surface side is shaped stepwise, the lens upper portion is formed thickest (about 30 mm) in the position near the second light incident portion 236 and becomes regularly thinner as it becomes more distant from the second light incident portion 236. In this case, a height of the lens upper portion is about 35 mm.

A light reflecting process is applied to the back surface side of the lens 230 except the first light incident surface 232a, the second light incident portion 236, and the housing 250. Concretely, a reflection layer 260 is formed by depositing the aluminum material. Because the reflection layer 260 is formed, a reflection efficiency of the first reflecting portion 233 and the second reflecting portion 237 can be improved and the traveling direction of the reflected light can be made uniform. Also, because the reflection layer 260 is seen when the lens 230 is viewed from the lens front side, a metallic texture is given.

A reflection and diffusion area 215 that continues in the lateral direction (the vertical direction to a surface of the sheet of FIG. 10) of the lens 230 is formed on the boundary portion between the lens upper portion and the lens lower portion (FIG. 3, FIG. 10). In the rear combination lamp 201, this reflection and diffusion area 215 functions as the barrier to the light and prevents the light leakage from the tail/stop lamp portion 210 to the turn lamp portion 220 and also the light leakage in the opposite direction.

The reflection and diffusion area 215 is formed by the laser beam machining, and has a multi-layered structure laminated in the vertical direction of the lens 230. For example, the reflection and diffusion area having two to eight layers may be formed. Each layer is formed of a set of fine cracks. A thickness of the reflection and diffusion area 215 (a length in the vertical direction) is about 5 mm. As shown in FIG. 10, the reflection and diffusion area 215 is formed close to the surface of the lens 230. Concretely, a distance between the reflection and diffusion area 215 and the lens front is about 3 mm, and a distance between the reflection and diffusion area 215 and the lens back surface is about 3 mm. In this manner, the light leakage can be suppressed to the lowest minimum by providing the reflection and diffusion area 215 that covers the boundary portion widely.

In contrast, in the lens lower portion shown in FIG. 3, a planar scattered reflection area 216 is formed on the right edge portion when viewed from the front side. The scattered reflection area 216 is formed by the laser beam machining and is formed of a set of fine cracks. In this case, the scattered reflection area 216 has a single-layer structure unlike the reflection and diffusion area 215, and has a thickness (a length in the lateral direction) of about 1 mm.

Next, a cooling mechanism in the rear combination lamp 201 will be explained hereunder. In the rear combination lamp 201, the first vent hole functions as a suction hole and the second vent hole functions as an exhaustion hole. Because the tail/stop lamp portion 210 whose frequency in use is high is arranged in the lower position, an updraft is generated in the housing 250. Accordingly, the suction via the first vent hole 251 and the exhaustion via the second vent hole 252 are promoted. Thus, the first lamp 240 is cooled by the external air flowing in through the first vent hole 251, and a heat generated from the second lamp 245 is discharged effectively to the outside together with the air flowing out through the second vent hole 252. As a result, a cooling of the overall equipment is executed effectively. In this manner, according to the rear combination lamp 201 of the present invention, although the configuration is simple, an effective cooling can be executed in light of the fact that the lamps whose frequency in use is different are provided in the housing. In addition, the fins of the heat sink 243 of the first lamp 240 are formed in parallel with the longitudinal direction (the lateral direction of a sheet in FIG. 10) of the lens 230. Thus, the fins of the heat sink 243 serve as the guide to flow the external air flowing in from the first vent hole 251 from the front side of the lens 230 to the rear side (from the left to the right of a sheet in FIG. 10). As a result, the external air flowing in the housing 250 from the first vent hole 251 can flow smoothly to the second vent hole 252, so that a cooling effect of the first lamp 240 can be enhanced.

Next, a lighting mode of the rear combination lamp 201 will be explained hereunder. First, when the tail lamp display is given, the first lamp 240 is lightened at a low brightness in response to an input signal from the vehicle side. A parallel light emitted from the first lamp 240 is introduced into the lens lower portion via the first light incident surface 232a. The introduced light reaches the first reflecting portion 233, is reflected there, and is converted into a light toward the lens front 231. The light generated in this way is radiated from the front of the lens lower portion (an area indicated by a reference 231a in FIG. 10).

A state of the tail/stop lamp portion 210 in emitting a light is shown schematically in FIG. 11. It can be seen that an area from which the light is emitted (the first reflecting portion 233) and an area from which the light is not emitted (the first coupling portion 234) appear alternately in the vertical direction. A mirror image 240a of the first lamp 240 can be seen in each first reflecting portion 233. Meanwhile, the first reflecting portion 233 constituting a convex surface functions as a convex mirror, and covers a wide area. Accordingly, a whole mirror image of the first lamp 240 can be seen on each first reflecting portion 233. That is, all first reflecting portions 233 show a complete mirror image of the first lamp 240, so that the design property can be improved.

As can be seen from FIG. 11, the first reflecting portions 233 are connected in the lateral direction while displacing upwardly by every distance equivalent to a half of one first reflecting portion 233. With this structure, a size of the stepped portions on the lens back surface side can be reduced and thus a molding of the lens 230 can be facilitated.

Here, the thick lens can be employed and also the light can be generated toward the lens front 231 by a plurality of first reflecting portions 233 being connected via the first coupling portions 234. Therefore, the front portion of the lens lower portion except the projection portion 217 serving as the reflex reflector emits the light as a whole.

By the way, a quantity of light reaching the first reflecting portion 233 in the position away from the first lamp 240 is smaller than a quantity of light reaching the first reflecting portion 233 in the position close to the first lamp 240. However, as understood from the above explanation, a distance of the first reflecting portion 233 in the position away from the first lamp 240 to the lens front 231 is short and thus the reflected light generated there is irradiated effectively from the first light emitting area 231a. In this way, a reduction of a quantity of light due to the distance from the first lamp 240 can be canceled by an increase of a light utility factor, and as a result a brightness of the light emitted from the first light emitting area 231a can be uniformized. In this case, a uniformization of a luminance brightness can be achieved by such a structure that the light from the first lamp 240 can be input into all first reflecting portions 233.

A part of the light propagating through the lens lower portion travels toward the lens upper portion. In the rear combination lamp 201, the reflection and diffusion area 215 acts as the barrier to this light. That is, the light traveling toward the lens upper portion is shut off by the reflection and diffusion area 215. Accordingly, the light leakage to the turn lamp portion 220 is prevented, and a parting, i.e., a boundary between the luminous area and the non-luminous area on the lens front 231 becomes clear, so that the luminous display that is excellent in the design property and the visibility can be provided. In this case, as described above, because the reflection and diffusion area 215 is constructed by the multi-layered structure, a high light blocking effect can be achieved.

In contrast, a part of the light propagating through the lens lower portion reaches the scattered reflection area 216 and is diffusedly reflected. Accordingly, when the user looks at the rear combination lamp 201 from obliquely above or the side, such user can watch the light caused due to the scattered reflection area 216 (i.e., planar light emission). In this manner, the luminous display with a wide view angle is given. Here, because the scattered reflection area 216 is formed thin and its forming position is set to the edge portion of the lens lower portion, it is prevented that the scattered reflection area 216 becomes conspicuous when viewed from the front, and at the same time an influence on the light guiding action is reduced.

In the tail/stop lamp portion 210, the thick lens 230 is employed as described above, the first lamp 240 is not arranged on the back surface side of the lens lower portion (the first lamp 240 is arranged on the lower edge side of the lens), and this lens 230 is designed such that a light incident directly on the first light incident surface 232a out of the external light incident from the lens front 231 is totally reflected by the boundary of the first light incident surface 232a portion. Thus, it can be prevented that the first lamp 240 is watched directly from the outside through the lens 230. In other words, when the lamp portion 210 is viewed from an a position or a b position in FIG. 10, the first lamp 240 is not viewed because of the total reflection caused by the lens front 231 or the first light incident surface 232a. When viewed from a c position, the reflection layer 260 is seen, and the presence of the first lamp 240 cannot be seen like the case where the lamp portion 210 is viewed from an a position or a b position. In this manner, although the configuration is simple, such configuration succeeded in concealing the presence of the first lamp 240 surely, and thus the lighting assembly having excellent design property and producing an unexpected feeling can be constructed.

By the way, the condition to generate the above total reflection is this embodiment is the same as the first embodiment as discussed before and as shown in FIG. 7. Accordingly, the detailed description about the condition is omitted.

The stop lamp display can be lightened in the similar lightening mode to the tail lamp display, except that the light having a higher brightness than the first light emitting area 231a can be obtained as the result that the first lamp 240 is lightened in high brightness.

In providing the turn signal display, the second lamp 245 is lightened in response to an input signal from the vehicle side, and an amber color light is introduced into the lens upper portion via the second light incident portion 236 provided to the lens upper portion. Like the case of the tail lamp display, this introduced light is converted into the light traveling toward the lens front 231b direction by the second reflecting portion 237 and thus the lens front 231b of the lens upper portion emits the light, so that the turn signal display is given. Also, like the tail/stop lamp portion 210, because a light utility factor in the area that is away from the second lamp 245 is increased, a brightness of the light emitted from the lens front 231b can be uniformized. In this case, in the lightening state of the turn lamp portion 220 similar to the lightening state of the tail/stop lamp portion 210, the reflection and diffusion area 215 exhibits the good blocking effect to prevent the light leakage. As a result, the luminous mode with the high design property and the high visibility can be attained.

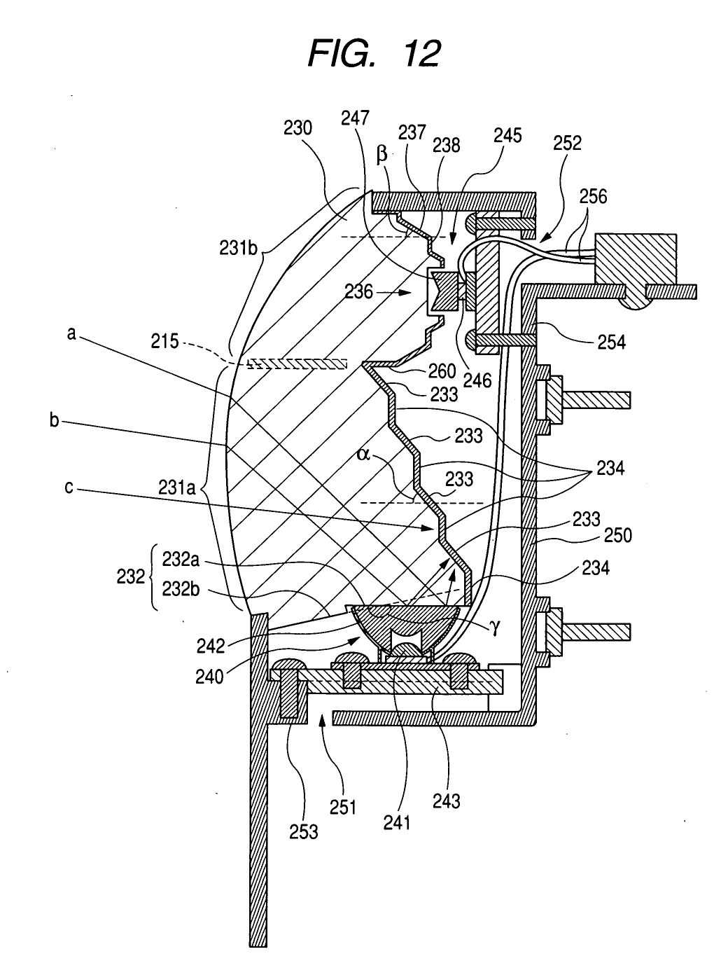

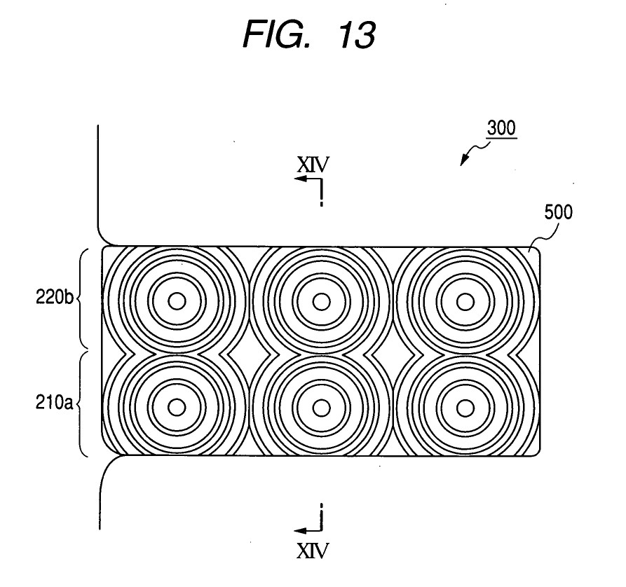

In this embodiment, the first light incident surface 232a and the light non-incident surface 232b of the lens 230 are formed in parallel with each other. As shown in FIG. 12, the first light incident surface 232a may be inclined with respect to the light non-incident surface 232b. In an example in FIG. 12, the first light incident surface 232a is inclined in the direction to reduce an angle between the first light incident surface 232a and the light non-incident surface 232b. An angle γ between the first light incident surface 232a and the light non-incident surface 232b is set to about 160°. This structure is effective in preventing such a situation that the first lamp 240 is viewed directly through the lens front 231. That is, an area through which the first lamp 240 cannot be seen directly can be enlarged by inclining the first light incident surface 232a. Thus, a margin in design of the lens front 231 is enhanced, and a reduction in thickness of the lens 230, and the like can be implemented. Also, the inclined arrangement of the first light incident surface 232a is effective in increasing the number and the area of the first reflecting portions 233. An increase of the reflecting portion contributes to a uniformization of the brightness. Here, an angle between the first light incident surface 232a and the light non-incident surface 232b is not particularly restricted, but normally the angle is set to 120° to 180°.

### Third Embodiment

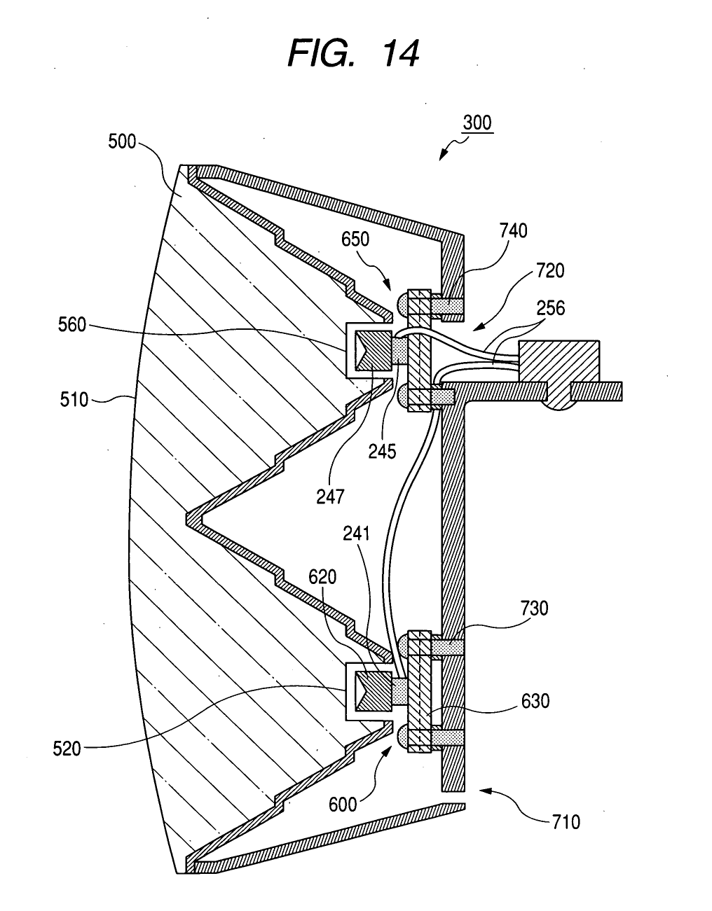

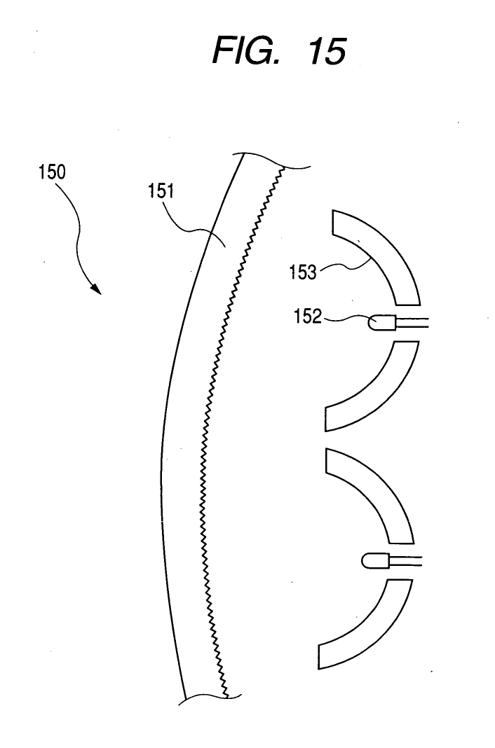

A front view of a rear combination lamp 300 as the third embodiment of the present invention is shown in FIG. 13, and a sectional view taken along a XIV-XIV line in FIG. 13 is shown in FIG. 14. In this case, the same reference symbols are affixed to the like members of the rear combination lamp 201 and their explanation will be omitted herein.

As shown in FIG. 13, the rear combination lamp 300, when classified roughly, is constructed by a lens 500, two types of LED lamps (the first lamp 240 and the second lamp 245), and a housing 700. In the rear combination lamp 300, a light emitted from a lens front 510 of the lens 500 irradiates directly the outside. That is, the lens front 510 of the lens 500 is the design surface of the rear combination lamp 300, and as a result the peculiar stereoscopic effect/crystal feeling can be obtained. The rear combination lamp 300 is constructed to show positively the first lamp 240 and the second lamp 245 on the design surface (the lens front 510).

The housing 700 is made of a synthetic resin, and has a first vent hole 710, a second vent hole 720, a fitting portion 730 for the first lamp 240, and a fitting portion 740 for the second lamp 245. The housing 700 is fitted to the back surface of the lens 500 by heat-plate depositing the edge portion of the housing 700 to the edge portion of the lens 500 on the back surface side such that a lower side 210a (a tail/stop lamp portion 210a) and an upper side 220a (a turn lamp portion 220a) are communicated with each other in the housing 700. Thus, the first vent hole 710 of the housing 700 is provided in a position that is near the first lamp 240 and is below the first lamp 240 (the lower portion of a sheet in FIG. 14). The first vent hole 710 has a slit-like shape of 3 mm width and 8 mm length, and is formed over the rear area of three first lamps 240. The second vent hole 720 is provided near the second lamp 245 in the housing 700. The wire harnesses 256 are connected to the substrate for the first lamp 240 and the substrate for the second lamp 245 through the second vent hole 720.

On the back surface side of the lens 500, three concave portions (first light incident surfaces 520) are formed at equal intervals on the lower side 210a (the tail/stop lamp portion 210a) and the light emergent portion of the first lamp 240 is involved in the concave portions respectively. Also, three concave portions (second light incident portions 560) are formed at equal intervals on the upper side 220a (the turn lamp portion 220a) and the light emergent portion of the second lamp 245 is involved in the concave portions respectively. A surface of the concave portion constituting the light incident portion 236a is a flat smooth surface and accordingly a light introducing efficiency can be enhanced. The second lamp 245 generates a light in the lateral direction (360° omnidirectional) by an action of the lens 247 provided over the amber LED lamp 246. Similarly, the first lamp 240 generates a light in the lateral direction (360° omnidirectional) by an action of a lens 620 provided over the red LED lamp 246.

The first lamp 240 has a heat sink 630 having rib-like fins. The heat sink 630 is made of aluminum, and is fitted to the back surface side of the first lamp 240. The fins of the heat sink 243 are formed in parallel with the vertical direction (the vertical direction of a sheet in FIG. 14) of the lens 500.

In the rear combination lamp 300, the fins of the heat sink 630 of the first lamp 240 are formed in parallel with the vertical direction of the lens 500. Thus, the fins of the heat sink 630 serve as the guide to flow the external air flowing in from the first vent hole 710 from the lower side of the lens 500 to the upper side (from the bottom to the top of a sheet in FIG. 14). As a result, the external air flowing in the housing 700 from the first vent hole 710 can flow smoothly to the second vent hole 720, so that the cooling effect of the first lamp 240 can be enhanced.

The present invention can be applied to the rear combination lamp for various vehicles (a passenger car, a bus, a truck, etc.).

The present invention can be utilized as the lighting assembly for various vehicles (a passenger car, a bus, a truck, etc.). Concretely, the present invention can be applied to the rear combination lamp, a tail lamp, a stop lamp, a high mounted stop lamp, a head lamp, a fog lamp, and the like.

The present invention is not restricted particularly to the explanation of the embodiments of the above invention. Various modes can be contained in this invention in a scope that the person skilled in the art can easily think of, without departing from the recitation in claims.

The entire contents of the paper, the patent publication gazette, the patent gazette, etc. cited in this specification are incorporated herein by reference.

What is claimed is:

1. A vehicle lighting assembly comprising:
a plurality of light sources; and
a light guiding body having a light incident portion and a reflecting portion corresponding to the light sources on a back surface side, for emitting a light generated when a light being incident from the light incident portion is reflected by the reflecting portion from a front portion;
wherein the light guiding body is divided into a plurality of blocks whose emergent light modes are different, and a reflection and diffusion area is formed on a boundary portion between two adjacent blocks.

2. A vehicle lighting assembly according to claim 1, wherein the reflection and diffusion area is formed on an overall area of the boundary portion except an area located in vicinity of a surface of the light guiding body.

3. A vehicle lighting assembly according to claim 1, wherein the reflection and diffusion area has a multi-layered structure.

4. A vehicle lighting assembly according to claim 1, wherein the reflection and diffusion area is formed of a set of fine cracks produced by a laser beam machining.

5. A vehicle lighting assembly according to claim 1, wherein a scattered reflection area that continues from a front surface side to the back surface side is formed on the light guiding body.

6. A vehicle lighting assembly according to claim 5, wherein the scattered reflection area is formed on either of left and right edge portions of the block.

7. A vehicle lighting assembly according to claim 5, wherein the scattered reflection area is a planar area.

8. A vehicle lighting assembly according to claim 1, wherein each of the light sources is formed of an LED lamp.

9. A vehicle lighting assembly comprising:
a light guiding body having a front light emitting surface, a back surface that underwent a light reflecting process, and a side edge surface; and
a light source arranged in a position that oppose to the side end surface;
wherein the light guiding body has a reflex reflector formed of an elongated portion that is elongated to conceal the light source, and
an external light, which goes directly to the side edge surface, out of the external light that is incident on the light guiding body via the front light emitting surface is totally reflected by a boundary of a side edge portion.

10. A vehicle lighting assembly according to claim 9, wherein a reflecting layer is formed on a back surface of the elongated portion.

11. A vehicle lighting assembly according to claim 9, wherein a distance between the front light emitting surface and the back surface of the light guiding body becomes shorter continuously or stepwise as a portion goes away from the side edge surface.

12. A vehicle lighting assembly according to claim 9, wherein a plurality of reflecting portions and coupling portions are formed on the back surface of the light guiding body to be connected alternately in a direction that goes away from the side edge surface, and the reflecting portions reflect the light introduced and reached there and generate the light toward the front light emitting surface.

13. A vehicle lighting assembly according to claim 9, wherein a thickness of the light guiding body on a side edge surface side is set to 1.5 mm to 50 mm.

14. A vehicle lighting assembly according to claim 13, wherein the front light emitting surface is shaped into a convex gentle surface.

15. A vehicle lighting assembly according to claim 13, wherein the light guiding body is fitted in a state that the side edge surface is directed downward.

16. A vehicle lighting assembly according to claim 9, wherein the side edge surface is a flat smooth surface.

17. A vehicle lighting assembly according to claim 9, wherein the light source is formed of an LED lamp.

18. A rear combination lamp, comprising:
a tail/stop lamp portion for emitting a light of a first lamp;
a turn lamp portion provided over the tail/stop lamp portion, for emitting a light of a second lamp; and
a housing for housing the first lamp and the second lamp therein;
wherein the tail/stop lamp portion and the turn lamp portion are in communication with each other in the housing, and the housing has a first vent hole near the first lamp and a second vent hole near the second lamp.

19. A rear combination lamp according to claim 18, wherein a lens for introducing a light of the first lamp via a light incident portion provided to a lower end and emitting the light from a front is provided to the tail/stop lamp portion, and
the lens is formed such that a thickness is reduced continuously or stepwise as a portion goes away from the lower end and also a plurality of reflecting portions and coupling portions are formed on a back surface side to be connected alternately in a direction to go away from the lower end, whereby each of the reflecting portions reflects a light introduced and reached there by a boundary and generate a light in a direction toward the front.

20. A rear combination lamp according to claim 19, wherein an external light, which goes directly on the lower end of the lens, out of the external light incident on the lens via the front of the lens is totally reflected by a boundary of the lower end.

21. A rear combination lamp according to claim 19, wherein the first lamp is arranged such that a light emitting side opposes to a lower end surface of the lens, the first lamp has a heat sink with rib-like fins, and the fins are parallel with a longitudinal direction of the lens.

22. A rear combination lamp according to claim 19, wherein the first vent hole is provided in a position ahead of the first lamp.

23. A rear combination lamp according to claim 18, wherein the first vent hole is shaped into a slit-like shape.

24. A rear combination lamp according to claim 18, wherein the first lamp and the second lamp are an LED lamp respectively.
